(19) United States
(12) Patent Application Publication
(10) Pub. No.: US 2006/0088767 A1
(43) Pub. Date: Apr. 27, 2006

(54) Battery with molten salt electrolyte and high voltage positive active material

(76) Inventors: Wen Li, Ann Arbor, MI (US); Yutaka Oyama, Aichi (JP); Masaki Matsui, Shizuoka (JP)

Correspondence Address: GIFFORD, KRASS, GROH, SPRINKLE & CITKOWSKI, P.C, PO BOX 7021, TROY, MI, 48007-7021, US

(21) Appl. No.: 11/216,555

(22) Filed: Aug. 31, 2005

Related U.S. Application Data
(60) Provisional application No. 60/606,409, filed on Sep. 1, 2004.
(60) Provisional application No. 60/614,517, filed on Sep. 30, 2004.

(51) Int. Cl. H01M 4/58; H01M 4/48; H01M 4/40; H01M 4/62; H01M 10/39

(52) U.S. Cl. 429/231.95; 429/231.1; 429/231.5; 429/188; 429/232; 429/224; 429/223

(57) ABSTRACT

A lithium-based rechargeable battery comprises a positive electrode, a negative electrode, and a molten salt electrolyte that is electrically conductive lithium ions. The positive electrode includes a positive active material that has an electrochemical potential of at least approximately 4.0 volts relative to lithium, and more preferably at least approximately 4.5 V relative to lithium. The electrolyte may further include a source of lithium ions, such as a lithium compound. Other rechargeable batteries using other ionic species can be fabricated to an analogous design.

### REFERENCE TO RELATED APPLICATION

This application claims priority of U.S. Provisional Patent Application Ser. Nos. 60/606,409, filed Sep. 1, 2004, and 60/614,517, filed Sep. 30, 2004, the content of both of which are incorporated herein by reference.

### FIELD OF THE INVENTION

The present invention relates to batteries, in particular to rechargeable lithium-based batteries.

### BACKGROUND OF THE INVENTION

Safety is a key issue for lithium ion (Li-ion) battery applications, particularly in automobiles. Conventional organic electrolytes have high vapor pressure, and are flammable. Molten salt electrolytes, also known as molten salts, have a low melting point and low vapor pressure, therefore they have potentially higher safety than organic electrolytes.

Lithium-based batteries, such as rechargeable Li-ion batteries, with a molten salt electrolyte may also provide higher energy/power density, compared to a conventional battery. Currently, the belief is that electrolyte decomposition seriously restricts applications of molten salt type Li-ion batteries. Demonstrating high voltage molten salt electrolyte lithium based batteries would be of great value.

### SUMMARY OF THE INVENTION

A battery according to an embodiment of the present invention is a lithium-based battery, such as a rechargeable lithium-ion battery, comprising a positive electrode, a negative electrode, and a molten salt electrolyte that is electrically conductive lithium ions. The positive electrode includes a positive active material that has an electrochemical potential of at least approximately 4.5 volts relative to lithium. The electrolyte may further include a source of lithium ions, such as a lithium compound. The electrolyte may include one or more lithium salts selected from the group consisting of LiPF₆, LiBF₄, LiAsF₆, LiClO₄, LiSO₃CF₃, LiTFSI, LiBETI, LiTSAC, LiB(CF₃COO)₄, and the like.

The positive active material and negative active material may both comprise materials that reversibly intercalate lithium ions. The positive active material may be a lithiated transition metal oxide, such as Li₂NiMn₃O₈, LiNiVO₄, LiCoVO₄, and Li[CoPO₄]. The positive active material may have the formula LiₓM_{y}N_{z}O, where M is selected from a group consisting of Ni, Mn, V, and Co, and N is a heteroatomic species different from M, such as Ni, Mn, V, Co, or P. N can be omitted. The positive active material may also be fluorinated, for example as a fluorophosphate.

The negative active material may also be a lithiated transition metal oxide, such as lithium titanium oxide or lithium cobalt oxide, and may also be a carbon-containing material (such as activated carbon) capable of reversibly intercalating lithium ions, a tin containing material, a silicon-containing material, or other material.

In other example batteries according to embodiments of the present invention, the negative active material comprises lithium metal, or an alloy thereof, and the battery is a rechargeable lithium battery. For example, the negative electrode may comprise a layer of lithium metal, or a lithium-aluminum alloy.

In an example battery, the molten salt electrolyte comprises an onium, such as a sulfonium, including fluorinated sulfoniums, and may comprise a trifluorosulfonylimide anion. Both the positive electrode and/or the negative electrode may further include an electron conductive material, such as a carbon-containing material, such as a carbon black. The molten salt electrolyte preferably includes a quaternary ammonium or ternary sulfonium species. Example molten salts include diethyl-methyl-sulfonium FSI, methyl-propyl-pyridinium FSI, and dimethyl-ethyl-imidazolium FSI.

Hence, an improved lithium based battery includes a molten salt electrolyte and a high voltage positive electrode. Lithium-based batteries include lithium ion batteries, lithium batteries having a lithium negative electrode, and similar batteries.

### BRIEF DESCRIPTION OF THE DRAWINGS

FIGS. 1A and 1B are schematics showing the possible structure of a high voltage Li-ion battery;

FIG. 2 shows CV results showing the oxidation potential of various molten salt electrolytes; and

FIG. 3 shows charge-discharge curves showing the performance of example batteries.

### DETAILED DESCRIPTION OF THE INVENTION

A battery according to an embodiment of the present invention comprises a negative electrode, a positive electrode, and an electrolyte. The positive electrode includes a positive active material having a potential greater than 4.5 volts compared with lithium. The positive active material is a lithiated transition metal compound, such as a lithium nickel manganese oxide, lithium nickel vanadium oxide, lithium cobalt vanadium oxide, or lithium cobalt phosphate, for example Li₂NiMn₃O₈, LiNiVO₄, LiCoVO₄, Li[CoPO₄], and the like. Other examples include lithium nickel phosphate, lithium nickel fluorophosphate, and lithium cobalt fluorophosphate; i.e. LiNiPO₄, Li₂NiPO₄F, Li₂CoPO₄F, and the like. The lithium content typically varies depending on the state of charge of the battery. The positive active material can comprise other oxygen-containing materials, such as an oxide, manganate, nickelate, vanadate, phosphate, or fluorophosphate. The electrolyte comprises a molten salt. The molten salt may have a trifluorosulfonylimide anion, or derivative thereof. The electrolyte may further include a source of lithium ions, such as a lithium salt. A high voltage positive active material allows greater energy densities to be achieved than for conventional batteries.

In a rechargeable lithium-ion battery and similar rechargeable batteries, the term anode is conventionally used for the negative electrode, and the term cathode is conventionally used for the positive electrode. These designations are technically correct only for the battery in a discharge cycle, however these designations are widely used in the literature and may be used herein. The term battery is used to refer to a device including one or more electrochemical cells.

Examples of the present invention include an improved Li-ion battery having a positive electrode including a high voltage positive active material having an electrochemical potential of at least 4V versus Li, and preferably greater than approximately 4.5V versus Li. An example battery comprises a negative electrode, a positive electrode, and an electrolyte, the electrolyte containing a molten salt and a lithium salt. The molten salt electrolyte can provide one or more of the following properties: high stability against oxidation, and high ionic conductivity for lithium ions. A Li-ion battery with a molten salt electrolyte and a high voltage positive electrode allows development of a high energy/power density Li-ion battery. Furthermore, molten salt electrolytes with FSI (fluorosulfonylimide) anion have very high ionic conductivity, and so can provide improved performance, such as higher power and energy.

An improved battery system includes a high voltage positive electrode and a molten salt electrolyte that comprises, for example, an FSI anion (fluorosulfonylimide or derivative thereof). The cation species of the molten salt can be, for example, a quaternary ammonium or ternary sulfonium. Example molten salt electrolytes include diethyl-methyl-sulfonium (DEMS) FSI, methyl-propyl-pyridinium (MPP) FSI, dimethyl-ethyl-imidazolium FSI, electrolytes having other imidazolium or pyridinium based anions including alkyl derivatives thereof, and the like.

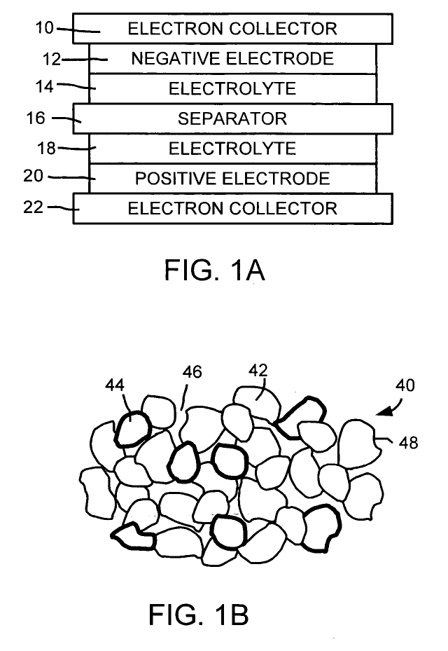

FIG. 1A shows an example Li-ion battery structure. The cell has a first electron collector 10, negative electrode 12, electrolyte layers 14 and 18, separator 16, positive electrode 20, and second electron collector 22. FIG. 1B shows a possible structure of the positive electrode, including particles of high potential positive active material 42, electron conductive material 44 (particles illustrated with thick edge lines), and electrolyte in the inter-particle gaps 46. The positive electrode may also include a binder on outer surfaces (such as 48) of the particles. The particles of electron conductive material may comprise electrically-conducting carbon or other electrically conducting material, and may present a surface layer comprising a barrier material which induces reduced electrolyte decomposition compared with that of a carbon surface.

In embodiments of the present invention, the positive active material (or cathode material) has a potential of between approximately 4.0 and the decomposition voltage of the molten salt electrolyte. Positive active potentials of up to 5.5 V may be achieved using materials such as LiNiPO₄, Li₂NiPO₄F, and Li₂CoPO₄F, as has been theoretically predicted.

The positive electrode includes a high voltage positive material as the positive active material, such as Li₂NiMn₃O₈, LiNiVO₄, LiCoVO₄, LiCoPO₄ and the like. For example, a positive electrode (positive electrode) can include a positive active material, a binder material, and an electron conductive material such as Acetiren Black.

The positive active material can be a lithiated transition metal compound such as an oxide (such as a manganate, nickelate, vanadate, cobaltate, titanate, or other compound such as other mixed transition metal oxides), a lithium mixed metal compound, and the like.

The binder material may include one or more of following compounds (or a mixture thereof): PVDF, PVDF-HFP, PTFE, PEO, PAN, CMC, SBR, and the like. These and other examples are described more fully below.

The negative active material can comprise Li-foil, Li₄Ti₅O₁₂, Si, Sn, Li/Al-alloy, Wood-metal (a eutectic alloy of Bi—Pb—Cd—Sn with composition is 50:25:12.5:12.5 weight %), other materials forming intermetallic compounds with lithium, and the like. For example, the negative electrode may include a negative active material, a binder material (such as PVDF, PVd-HFP, PTFE, PEO, PAN, CMC, SBR, and the like), and an electron conductive material such as Acetiren Black. The electrolyte can comprise a molten salt (such as DEMS-FSI or MPP-FSI), and a lithium salt.

The molten salt can include an onium, such as an ammonium, a phosphonium, an oxonium, a sulfonium, an amidinium, an imidazolium, a pyrazolium, and a low basicity anion, such as PF₆⁻, BF₄⁻, CF₃SO₃⁻, (CF₃SO₂)N⁻, (FSO₂)₂N⁻. The molten salt electrolyte may also include Y⁺N⁻(—SO₂Rf²)(—XRf³), where Y⁺ is a cation selected from the group consisting of an imidazolium ion, an ammonium ion, a sulfonium ion, a pyridinium, a(n) (iso)thiazolyl ion, and a(n) (iso) oxazolium ion, which may be optionally substituted with C₁₋₁₀ alkyl or C₁₋₁₀ alkyl having ether linkage, provided that said cation has at least one substituent of —CH₂Rf¹ or —OCH₂Rf¹ (where Rf is C₁₋₁₀ polyfluoroalkyl); Rf² and Rf³ are independently C₁₋₁₀ perfluorophenyl or may together be C₁₋₁₀ perfluoroalkylene; and X is —SO₂— or —CO—.

For improved stability, the cation of the molten salt should have an oxidation potential at least approximately 0.5V above the cathode voltage.

The lithium salt may be LiPF₆, LiBF₄, LiAsF₆, LiClO₄, LiSO₃CF₃, LiTFSI, LiBETI, LiTSAC, LiB(CF₃COO)₄, and the like, or a mixture of lithium compounds.

The separator may include micro-porous PE, PP or PE/PP-hybrid film, bonded-fiber fabric of PP, PET, or methyl cellulose, and the like.

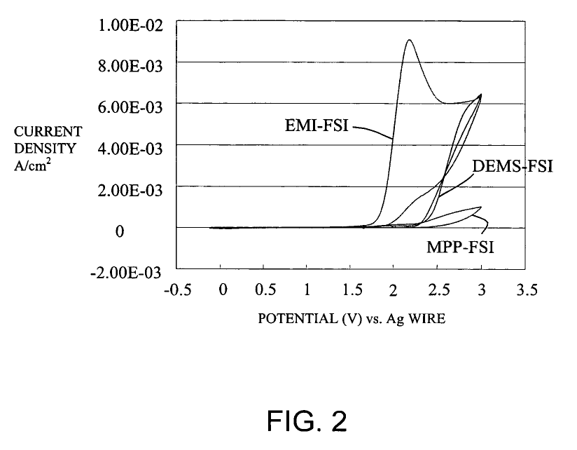

CV results (FIG. 2) show that the EMI cation in a molten salt electrolyte has lower oxidation potential than the DEMS (diethyl-methyl-sulfonium) or MPP (methyl-propyl-pyridinium) cation. When a conventional Li-ion battery with high voltage (over 4.5V versus Li) positive electrode was charged, decomposition of the electrolyte was found. Experimental results suggested that the electrolyte decomposition resulted from the low oxidation stability of the EMI cation.

### EXAMPLE 1

A positive active material paste was prepared by dispersing 85 parts by weight of Li₂NiMn₃O₈ and 10 parts by weight of carbon powder and 5 parts by weight of polyvinylidene fluoride in N-methylpyrrolidone, and was coated by the doctor blade method to form an active material thin film on aluminum sheet. The coating film was dried for 30 minutes in an oven at 80° C.

A negative active material paste was prepared by dispersing 85 parts by weight of Li₄Ti₅O₁₂ parts by weight of carbon powder and 5 parts by weight of polyvinylidene fluoride in N-methylpyrrolidone, and was coated by the doctor blade method to form an active material thin film on aluminum sheet. The coating film was dried for 30 minutes in an oven of 80° C.

The positive electrode sheet, a micro-porous polypropylene film separator, and the negative electrode sheet were stacked, and placed in aluminum laminate pack. A certain amount of molten salt electrolyte was added in to the laminate pack. Here, DEMS-FSI with lithium-bis-trifluoromethan-sulfonylimide (LiTFSI) was used as the molten salt electrolyte. The aluminum laminate pack was sealed in vacuum to give a soft package battery.

### EXAMPLE 2

Methyl-propyl-pyridinium-bis-fluoro-sulfonylimide (MPP-FSI) with lithium-bis-trifluoromethan-sulfonylimide (LiTFSI) was used as the molten salt electrolyte. Other details are the same as Example 1.

### REFERENCE

Ethyl-methyl-imidazolium-bis-fluoro-sulfonylimide (EMI-FSI) with lithium-bis-trifluoromethan-sulfonylimide (LiTFSI) was used as the molten salt electrolyte. Other details are the same as Example 1.

### DATA COLLECTION

The batteries were charged and discharged under the following conditions:
electric current density: 0.7 mA/cm²;
charge-termination voltage: 3.5 V; and
discharge-termination voltage: 1.5V,
to determine the charge-discharge performance.

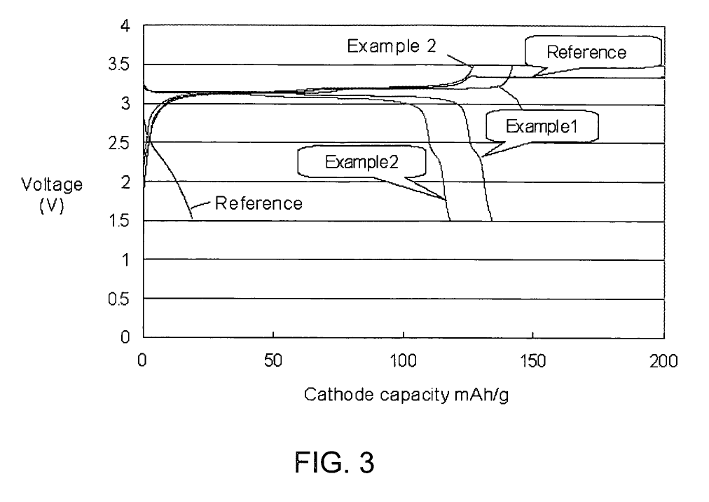

FIG. 3 shows the results for the batteries of Examples 1 and 2, and the reference battery. The example batteries provide excellent performance. The reference battery (Reference) failed to fully charge, as indicated by the horizontal portion of the charge density curve. The battery of Example 2 gave excellent results, though the curves indicate that the discharge capacity was slightly less than the charging capacity.

Hence, improved battery systems as described herein, with a molten salt electrolyte and a high voltage positive electrode, allowing high energy and high power Li-ion battery. In the examples (Example 1 and Example 2) described above, the decomposition of the molten salt electrolyte occurred at about 5.2 V relative to lithium. Hence, positive electrodes having positive active materials (cathode materials) with a potential in the range of approximately 4.0 to approximately 5.2 V provide excellent performance in conjunction with a molten salt electrolyte.

More preferably, the positive active material has a potential of at least approximately 4.5 V, so as to further increase the power available. The positive active material preferably has a potential less than that at which the electrolyte decomposition is observed. Hence, an example battery according to the present invention, the positive active material has a potential of between approximately 4.5 V and 5.2 V.

Regarding the battery having an EMI-FSI containing molten salt electrolyte, our co-pending U.S. patent application Ser. No. 11/080,617 and U.S. provisional patent application Ser. No. 60/614,517 describe non-graphitic barrier materials which can substantially prevent molten salt electrolyte decomposition. Molten salt electrolyte decomposition has been observed on graphitic carbon-containing electron conductive materials. The barrier materials, which do not comprise electron-conducting carbon, can be used as surface coating (or barrier) on an interior material, the interior material being one that may otherwise induce decomposition of the electrolyte. However, electron conductive particles may be constituted substantially or entirely of one or more barrier materials. Electron-conductive materials may comprise substantially homogeneous particles formed from the barrier material, or may comprise an interior material having a coating of the barrier material. The interior material may comprise electrically conductive carbon such as carbon black, or in other examples metals having a high electrical conductivity such as platinum (Pt), tungsten (W), aluminum (Al), copper (Cu) and silver (Ag), metal oxides such as Tl₂O₃, WO₂ and Ti₄O₇, and metal carbides such as WC, TiC and TaC.

Such barrier materials include oxides of at least one metal in group 4 to 14 of the periodic table. For example, the barrier material may comprise an oxide of at least one metal in group 4 to 6 of the periodic table. Examples of an element in such an oxide are elements in groups 4 to 6 of the periodic table (Ti, Zr, Hf, V, Nb, Ta, Cr, Mo, W). An example of such a metal oxide is a titanium oxide. Other examples are elements in groups 12 to 14 of the periodic table (such as Zn, Al, In, Tl, Si, Sn). An example of such an oxide is an indium-tin oxide (ITO). Specific preferable examples of an oxide constituting the barrier layer include SnO₂, TiO₂, Ti₄O₇, In₂O₃/SnO₂ (ITO), Ta₂O₅, WO₂, W₁₈O₄₉, CrO₂ and Tl₂O₃. With these oxides, the oxidation number of the metal in the oxide is relatively high, and hence the resistance to oxidation is good. Moreover, other preferable examples of an oxide constituting the barrier layer include MgO, BaTiO₃, TiO₂, ZrO₂, Al₂O₃, and SiO₂. These oxides have excellent electrochemical stability.

The barrier material may comprise a carbide of at least one metal in group 4 to 14 of the periodic table, for example, a carbide of at least one metal in group 4 to 6 of the periodic table (Ti, Zr, Hf, V, Nb, Ta, Cr, Mo and W). Examples of such a metal carbide include a titanium carbide (e.g. TiC) and a tantalum carbide (e.g. TaC). Specific examples of such a carbide are carbides represented by the formula MC (M is selected from Ti, Zr, Hf, V, Nb, Ta, Mo and W) and carbides represented by the formula M₂C (M is selected from V, Ta, Mo and W). Other examples include metal phosphides such as Ni₂P₃, Cu₂P₃, and FeP.

Such barrier materials were shown to reduce molten salt electrolyte decomposition using a Li₂NiMn₃O₈ high voltage cathode material, as described in U.S. provisional patent application Ser. No. 60/614,517.

The barrier material may comprise a nitride of at least one element in groups 2 to 14 and the third or subsequent period of the periodic table, preferable examples of an element in such a nitride being elements in groups 4 to 6 of the periodic table (Ti, Zr, Hf, V, Nb, Ta, Cr, Mo and W). The barrier material may also comprise tungsten. The group numbers in the periodic table indicated in this specification follow the indication of group numbers 1 to 18 according to the 1989 IUPAC revised edition of inorganic chemical nomenclature. With a barrier layer consisting of at least one selected from (a) oxides, (b) carbides, (c) nitrides, and (d) metallic tungsten as described above, the activity of the barrier material (and hence the electron conducting materials in the positive electrode) to oxidative decomposition of the electrolyte may be lower than that of at least carbon.

Hence, a battery according to an embodiment of the present invention comprises a positive electrode including a positive active material, a negative electrode including a negative active material, and an electrolyte, the electrolyte comprising a molten salt, wherein the positive active material has an electrochemical potential of at least approximately 4.0 volts relative to lithium and more preferably 4.5 V relative to lithium. The positive electrode further comprises an electron conducting material that does not induce substantial decomposition of the electrolyte. For some molten salts, for example as shown in Examples 1 and 2, this may be a graphitic carbon-based material, such as carbon black. However, if electrolyte decomposition is observed, as in the case of EMI-FSI electrolyte reference example described above, the carbon-based electron conducting material can be readily replaced with a barrier material as described above, for example using particles having a carbon based or other interior and a barrier layer coating. Hence, high energy batteries according to the present invention are readily fabricated.

Batteries according to examples of the present invention have a molten salt electrolyte. The term molten salt electrolyte is used herein to represent an electrolyte including one or more molten salts as a significant component of the electrolyte, for example more than 50% of the electrolyte. A molten salt electrolyte is an electrolyte comprising one or more salts, that is at least in part molten (or otherwise liquid) at the operating temperatures of the battery. A molten salt electrolyte can also be described as a molten, non-aqueous electrolyte, as an aqueous solvent is not required, or as an ionic liquid.

Molten salt electrolytes which may be used in embodiments of the invention are described in U.S. Pat. Nos. 4,463,071 to Gifford, 5,552,241 to Mamantov et al., 5,589,291 to Carlin et al., 6,326,104 to Caja et al., 6,365,301 to Michot, and 6,544,691 to Guidotti.

Example molten salts include those having an aromatic cation (such as an imidazolium salt or a pyridinium salt), an aliphatic quaternary ammonium salt, or a sulfonium salt. The molten salt electrolyte in the invention may include an onium, such as an ammonium, a phosphonium, an oxonium, a sulfonium, an amidinium, an imidazolium, a pyrazolium, and an anion, such as PF₆⁻, BF₄⁻, CF₃SO₃⁻, (CF₃SO₂)₂N⁻, (FSO₂)₂N⁻, (C₂F₅SO₂)₂N⁻, Cl⁻ and Br⁻.

A molten salt electrolyte used in an example of the present invention may include Y⁺N⁻(—SO₂Rf²)(—XRf³), where Y⁺ is a cation selected from the group consisting of an imidazolium ion, an ammonium ion, a sulfonium ion, a pyridinium, a(n) (iso)thiazolyl ion, and a(n) (iso) oxazolium ion, which may be optionally substituted with C₁₋₁₀ alkyl or C₁₋₁₀ alkyl having ether linkage, provided that said cation has at least one substituent of —CH₂Rf¹ or —OCH₂Rf¹ (where R^{f1} is C₁₋₁₀ polyfluoroalkyl); Rf² and Rf³ are independently C₁₋₁₀ perfluorophenyl or may together from C₁₋₁₀ perfluoroalkylene; and X is —SO₂— or —CO—.

Molten salts include salts having an aromatic cation (such as an imidazolium salt or a pyridinium salt), aliphatic quaternary ammonium salts, and sulfonium salts.

Imidazolium salts include salts having a dialkylimidazolium ion, such as a dimethylimidazolium ion, an ethylmethylimidazolium ion, a propylmethylimidazolium ion, a butylmethylimidazolium ion, a hexylmethylimidazolium ion or an octylmethylimidazolium ion, or a trialkylimidazolium ion such as a 1,2,3-trimethylimidazolium ion, a 1-ethyl-2,3-dimethylimidazolium ion, a 1-butyl-2,3-dimethylimidazolium ion or a 1-hexyl-2,3-dimethylimidazolium ion. Imidazolium salts include ethylmethylimidazolium tetrafluoroborate (EMI-BF₄), ethylmethylimidazolium trifluoromethanesulfonylimide (EMI-TFSI), propylmethylimidazolium tetrafluoroborate, 1,2-diethyl-3-methylimidazolium trifluoromethanesulfonylimide (DEMI-TFSI), and 1,2,4-triethyl-3-methylimidazolium trifluoromethanesulfonylimide (TEMI-TFSI).

Pyridinium salts include salts having an alkyl pyridinium ion, such as a 1-ethylpyridinium ion, a 1-butylpyridinium ion or a 1-hexylpyridinium ion. Pyridinium salts include 1-ethylpyridinium tetrafluoroborate and 1-ethylpyridinium trifluoromethanesulfonylimide.

Ammonium salts include trimethylpropylammonium trifluoromethanesulfonylimide (TMPA-TFSI), diethylmethylpropylammonium trifluoromethanesulfonylimide, and 1-butyl-1-methylpyrrolidinium trifluoromethanesulfonylimide. Sulfonium salts include triethylsulfonium trifluoromethanesulfonylimide (TES-TFSI).

In a secondary battery operating through the migration of cations, the electrolyte typically contains a cation source, providing cations according to the type of battery. In the case of a lithium ion battery, the cation source can be a lithium salt. Lithium salts in the electrolyte of a lithium-ion battery may include one or more of the following: LiPF₆, LiAsF₆, LiSbF₆, LiBF₄, LiClO₄, LiCF₃SO₃, Li(CF₃SO₂)₂N, Li(C₂F₅SO₂)₂N, LiC₄F₉SO₃, Li(CF₃SO₂)₃C, LiBPh₄, LiBOB (lithium bis(oxalato)borate), and Li(CF₃SO₂)(CF₃CO)N, and the like. Examples of the present invention can include rechargeable batteries using ions other than lithium, such as other alkali metal or other cation based batteries, in which case an appropriate salt is used. For example, the molten salt of a potassium-ion battery may include KPF₆ or other potassium-ion providing compound.

The positive active material can be a material allowing reversible cation insertion and release thereof. In the case of a lithium ion battery, the positive active material can be a lithium composite oxide, such as a lithium metal oxide (an oxide of lithium and at least one other metal species). Example lithium composite oxides include Li—Ni-containing oxides, Li—Mn-containing oxides, Li—Co-containing oxides, other lithium transition metal oxides, lithium metal phosphates (such as LiCoPO₄ and fluorinated lithium metal phosphates), and other lithium metal chalcogenides, where the metal is, for example, a transition metal. Lithium composite oxides include oxides of lithium and one or more transition metals, and oxides of lithium and one or more metals selected from the group consisting of Co, Al, Mn, Cr, Fe, V, Mg, Ti, Zr, Nb, Mo, W, Cu, Zn, Ga, In, Sn, La and Ce. The positive active material may by nanostructured, for example in the form of nanoparticles having a mean diameter less than one micron.

The negative electrode can comprise a negative active material, and (optionally) an electron conductive material and a binder. The negative electrode may be formed in electrical communication with a negative electrode electron collector. The negative active material may be carbon based, such as graphitic carbon and/or amorphous carbon, such as natural graphite, mesocarbon microbeads (MCMBs), highly ordered pyrolytic graphite (HOPG), hard carbon or soft carbon, or a material comprising silicon and/or tin, or other components. The negative electrode may be a lithium titanium oxide, such as Li₄Ti₅O₁₂.

Rechargeable batteries according to examples of the present invention include those based on any cation that can be reversibly stored (for example, inserted or intercalated) and released. Cations may include positive ions of alkali metals such as lithium, sodium, potassium, and cesium; alkaline earth metals such as calcium and barium; other metals such as magnesium, aluminum, silver and zinc; and hydrogen. In other examples, cations may be ammonium ions, imidazolium ions, pyridinium ions, phosphonium ions, sulfonium ions, and derivatives thereof, such as alkyl or other derivatives of such ions. In the example of a rechargeable battery using cations of species X, a battery according to an embodiment of the present invention comprises a negative electrode, a positive electrode, and a molten salt electrolyte, where the electrolyte is electrically conductive to cations of X, but not of electrons, the negative electrode includes a negative active material which can reversibly store (e.g. intercalate) cations of X (or which may comprise a layer of X), and a positive active material having an electrochemical potential of approximately 4.5 V or greater relative to X.

Electron conductive materials which may be used in electrodes of batteries according to examples of the present invention may comprise a carbon-containing material, such as graphite. Other example electron-conductive materials include polyaniline or other conducting polymer, carbon fibers, carbon black (or similar materials such as acetylene black, or Ketjen black), and non-electroactive metals such as cobalt, copper, nickel, other metal, or metal compound. The electron conducting material may be in the form of particles (as used here, the term includes granules, flakes, powders and the like), fibers, a mesh, sheet, or other two or three-dimensional framework. Electron conductive materials also include non-graphitic materials, which can help reduce electrolyte decomposition. Examples of non-graphitic electron conducting materials include oxides such as SnO₂, Ti₄O₇, In₂O₃/SnO₂ (ITO), Ta₂O₅, WO₂, W₁₈O₄₉, CrO₂ and Tl₂O₃, carbides represented by the formula MC (where M is a metal, such as WC, TiC and TaC), carbides represented by the formula M₂C, metal nitrides, and metallic tungsten. An electron conducting particle may include a conducting core, and a coating chosen to reduce or eliminate decomposition of the electrolyte, for example as disclosed in our co-pending U.S. patent application Ser. No. 11/080,617.

An example battery may further include electrical leads and appropriate packaging, for example a sealed container providing electrical contacts in electrical communication with the first and second current collectors.

An electron collector, also known as a current collector, can be an electrically conductive member comprising a metal, conducting polymer, or other conducting material. The electron collector may be in the form of a sheet, mesh, rod, or other desired form. For example, an electron collector may comprise a metal such as Al, Ni, Fe, Ti, stainless steel, or other metal or alloy. The electron collector may have a barrier layer to reduce corrosion, for example a barrier layer comprising tungsten (W), platinum (Pt), titanium carbide (TiC), tantalum carbide (TaC), titanium oxide (for example, TiO₂ or Ti₄O₇), copper phosphide (Cu₂P₃), nickel phosphide (Ni₂P₃), iron phosphide (FeP), and the like, or may comprise particles of such materials. As also described in our co-pending U.S. patent application Ser. No. 11/080,617, the use of such barrier layers also allows organic solvent based electrolytes to be used. Hence, improved batteries according to embodiments of the present invention may have organic solvent based electrolytes and high voltage positive electrodes (high voltage cathodes).

One or both electrodes may further include a binder. The binder may comprise one or more inert materials, for the purpose of improving the mechanical properties of the electrode, facilitating electrode manufacture or processing, or other purpose. Example binder materials include polymers, such as polyethylene, polyolefins and derivatives thereof, polyethylene oxide, acrylic polymers (including polymethacrylates), synthetic rubber, and the like. Binders also include fluoropolymers such as polyvinylidene fluoride (PVdF), polytetrafluoroethylene (PTFE), poly(vinylidene fluoride-hexafluoropropylene) copolymers (PVDF-HFP), and the like. Binder materials may include PEO (poly(ethylene oxide), PAN (polyacrylonitrile), CMC (carboxy methyl cellulose), SBR (styrene-butadiene rubber), or a mixture of compounds, including composite materials, copolymers, and the like. An adhesion promoter can be further be used to promote adhesion of an electrode to an electron collector.

A battery may comprise a separator between the positive and negative electrodes. Batteries may include one or more separators, located between the negative electrode and positive electrode for the purpose of preventing direct electrical contact (a short circuit) between the electrodes. A separator can be an ion-transmitting sheet, for example a porous sheet, film, mesh, or woven or non-woven cloth, fibrous mat (cloth), or other form. The separator is optional, and a solid electrolyte may provide a similar function. A separator may be a porous or otherwise ion-transmitting sheet, including a material such as a polymer (such as polyethylene, polypropylene, polyethylene terephthalate, methyl cellulose, or other polymer), sol-gel material, ormosil, glass, ceramic, glass-ceramic, or other material. A separator may be attached to a surface of one or both electrodes.

Patents, patent applications, or publications mentioned in this specification are incorporated herein by reference to the same extent as if each individual document was specifically and individually indicated to be incorporated by reference. In particular, U.S. Prov. Pat. App. Ser. Nos. 60/606,409 and 60/614,517 are incorporated herein in their entirety.

The invention is not restricted to the illustrative examples described above. Examples are not intended as limitations on the scope of the invention. Methods, apparatus, compositions, and the like described herein are exemplary and not intended as limitations on the scope of the invention. Changes therein and other uses will occur to those skilled in the art. The scope of the invention is defined by the scope of the claims.

Having described our invention, we claim:

1. A battery, comprising
a positive electrode including a positive active material;
a negative electrode including a negative active material; and
an electrolyte, the electrolyte comprising a molten salt,
wherein the positive active material has an electrochemical potential of at least approximately 4.0 volts relative to lithium,
the battery being a rechargeable lithium-based battery.

2. The battery of claim 1, wherein the positive active material has an electrochemical potential of at least approximately 4.5 V relative to lithium.

3. The battery of claim 1, wherein the electrolyte includes a lithium compound, the lithium compound providing a source of lithium ions.

4. The battery of claim 1, wherein the negative active material reversibly intercalates lithium ions, and the battery is rechargeable lithium-ion battery.

5. The battery of claim 4, wherein the negative active material comprises a lithiated transition metal oxide.

6. The battery of claim 4, wherein the negative active material comprises lithium titanium oxide.

7. The battery of claim 1, wherein the negative active material comprises lithium, and the battery is a rechargeable lithium battery.

8. The battery of claim 7, wherein the negative active material is a layer of lithium metal.

9. The battery of claim 7, wherein the negative active material comprises a lithium-containing alloy.

10. The battery of claim 1, wherein the negative active material comprises a lithium-aluminum alloy.

11. The battery of claim 1, wherein the positive active material comprises a lithiated transition metal compound.

12. The battery of claim 11, wherein the lithiated transition metal compound is selected from a group of compounds consisting of lithium nickel manganese oxide, lithium nickel vanadium oxide, lithium cobalt vanadium oxide, lithium cobalt phosphate, lithium nickel phosphate, lithium nickel fluorophosphate, and lithium cobalt fluorophosphate.

13. The battery of claim 1, wherein the positive active material is represented by a formula LiₓM_{y}N_{z}OFₐ, where:
M is selected from a first group consisting of Ni, Mn, V, and Co;
N is selected from a second group consisting of transition metals and phosphorus;
M and N are non-identical; and
wherein subscripts x and y are non-zero, and subscripts z and a are non-zero or zero.

14. The battery of claim 1, wherein the positive active material reversibly intercalates lithium ions.

15. The battery of claim 1, wherein the molten salt electrolyte comprises an onium.

16. The battery of claim 1, wherein the molten salt electrolyte comprises a sulfonium.

17. The battery of claim 1, wherein the molten salt electrolyte comprises a fluorosulfonylimide.

18. The battery of claim 1, the positive electrode comprising an electron conducting material;
the electron conducting material being particles having a barrier material in contact with the molten salt electrolyte;
the barrier material not being an electrically conducting carbon, and not inducing substantial decomposition of the electrolyte.

19. A battery, comprising
a positive electrode including a positive active material;
a negative electrode including a negative active material; and
an electrolyte, the electrolyte comprising a molten salt, the electrolyte being electrically conductive to a cation, the cation being the cationic form of a species, wherein:
the positive active material is capable of reversibly intercalating the cation, and
the positive active material has an electrochemical potential of at least approximately 4.5 volts relative to the species.

20. The battery of claim 19, wherein the species is an alkali metal.

21. The battery of claim 20, wherein the alkali metal is lithium, the cation being a lithium ion.

22. The battery of claim 19, wherein the molten salt electrolyte includes a trifluorosulfonylimide anion.

23. The battery of claim 19, wherein the negative active material is capable of reversibly intercalating the cation.

24. The battery of claim 19, wherein the negative active material includes the species in an elemental form.
